(19) United States
(12) Patent Application Publication
(10) Pub. No.: US 2005/0260371 A1
(43) Pub. Date: Nov. 24, 2005

(54) Preform for low natural stretch ratio polymer, container made therewith and methods

(76) Inventors: Yu Shi, Alpharetta, GA (US); Christopher C. Kjorlaug, Alpharetta, GA (US); Linda K. Anthony, Alpharetta, GA (US); Thomas H. Milton, Greensboro, NC (US)

Correspondence Address: SUTHERLAND ASBILL & BRENNAN LLP, 999 PEACHTREE STREET, N.E., ATLANTA, GA, 30309, US

(21) Appl. No.: 11/126,962

(22) Filed: May 11, 2005

Related U.S. Application Data
(63) Continuation-in-part of application No. 10/967,803, filed on Oct. 18, 2004.
Application No. 10/967,803 is a continuation of application No. 10/696,858, filed on Oct. 30, 2003, now abandoned.
(60) Provisional application No. 60/423,221, filed on Nov. 1, 2002.

(51) Int. Cl. B65D 1/00; B29C 49/06

(52) U.S. Cl. 428/35.7; 264/537

(57) ABSTRACT

An injection molded preform for making a stretch blow molded container having an overall stretch ratio of from about 8 to about 12, wherein the overall stretch ratio is a product of a hoop stretch ratio and an axial stretch ratio, wherein the hoop stretch ratio is from about 4.5 to about 5.4, wherein the axial stretch ratio is from about 1.5 to about 2.2, and wherein the preform comprises a LNSR PET Copolymer having a free blow volume of from about 400 to less than about 650 ml measured at 100° C. and 90 psi using a 25 gram weight preform designed for a 500 ml container with a maximum diameter of 65 mm and a height of 200 mm from below the container finish and having a hoop stretch ratio of 5.5 and an axial stretch ratio of 2.6. This invention also relates to a method of making such preforms and stretch blow molded containers and methods of making the same.

### CROSS REFERENCE TO RELATED APPLICATIONS

This application is a continuation-in-part of U.S. patent application Ser. No. 10/967,803 filed in the U.S. Patent and Trademark Office on Oct. 18, 2004, which is a continuation of U.S. patent application Ser. No. 10/696,858 filed in the U.S. Patent and Trademark Office on Oct. 30, 2003, which claims priority under 35 U.S.C. §119 to U.S. provisional patent application Ser. No. 60/423,221 filed on Nov. 1, 2002, the disclosures of which applications are expressly incorporated herein by reference in their entirety.

### FIELD OF THE INVENTION

This invention relates to preform designs and preforms made therefrom, as well as making such preforms. The present invention also relates to stretch blow molded containers and methods of making the same. The present invention also pertains to methods of making stretch blow molded containers.

### BACKGROUND OF THE INVENTION

Poly(ethylene) terephthalate resins are commonly referred to in the industry as “PET” even through they may and often do contain minor amounts of additional components. PET is widely used to manufacture containers for juice, water, carbonated soft drinks (“CSD”) and the like. PET is used for these purposes due to its generally excellent combination of mechanical and gas barrier properties.

The PET containers referred to herein are stretch blow molded containers. As would be recognized by one of ordinary skill in the art, stretch blow molded PET containers are manufactured by first preparing an injection molded preform from PET resin. The PET resin is injected into the preform mold that is of a certain configuration. In prior art methods of container manufacturer, configuration of the preform is dictated by the final container size and the properties of the polymer being used to prepare the container. After preparation of the preform, the preform is blow molded to provide a stretch blow molded container.

PET containers must conform to fairly rigid specifications, especially when used to contain and store carbonated beverages in warm climates and/or in the summer months. Under such conditions, the containers often undergo thermal expansion, commonly referred to in the industry as “creep”, caused by the high pressure in the container at high temperature. The expansion increases the space between the PET molecules in the side wall of the container thus allowing for CO2 to escape through the side wall faster than under normal conditions. Expansion also increases the head space of the container, which allows carbonation to escape from the beverage into the headspace area. Regardless of how carbonation is released from the beverage while enclosed in a container, loss of carbonation is undesirable because the beverage will taste “flat” when this occurs. Creep increases the interior space in the container which, in turn, reduces the height of the beverage in the container. This reduced height can translate into a perception by the consumer that the container is not completely full and, as such, perception of product quality is reduced.

PET container performance is also relevant in regards to sidewall strength. In storage and transport, filled PET containers are normally stacked with several layers of filled containers on top of each other. This causes significant vertical stress on the container which is manifested in large part against the sidewalls. If there is not sufficient sidewall strength or top load in the PET container, the container can collapse in storage or in use.

Moreover, consumer perception of container quality is manifested in the feel of the container when it is being held. When consumer hold a container and squeeze the container, the contain sidewall will deform. If sidewall deflection is too high, the container will feel too soft; and consumers relate this to a poor quality of products, even though the products are of the same quality as compared with products packed in a stiffer package.

One of ordinary skill in the art would recognize that it is desirable to reduce the amount of PET used in the preparation of PET containers for cost reduction. Lower weight PET containers result in lower material costs, less energy usage during the manufacturing process and lower transport costs. Lighter weighted containers also provide less solid waste and have less negative environmental impact. However, with reducing the amount of PET per container the desired properties mentioned above are also sacrificed, thus achieving a balance between source reduction and performance is difficult to achieve.

Prior art methods of reducing the weight of PET containers generally focus on reduction of the amount of polymer used to prepare the container. The weight of the container can be reduced to an amount that is shown through performance testing to not dramatically sacrifice performance of the containers in use, although some deterioration in container performance are seen with prior art methods of lightweighting where no barrier coating is used. Generally, the above-described container properties are directly related to the amount of PET resin used to prepare the container. In prior art methods of light weighting containers, lower amounts of PET resin used will result in thinner-walled finished containers and will consequently result in lower barrier and strength properties in the finished container. Thus, the tension between maximizing the performance of PET containers while attempting to reduce the weight of PET containers remains a concern, especially in warmer climates.

Energy consumption during the container manufacturing process is directly related to the thickness of the preform, because in a thicker preform there is more polymer mass present to heat and cool. Therefore, one method to reduce energy costs associated with preparation of PET containers is to lightweight the preform by reducing the thickness of the preform. Prior art methods for doing so involve making a core change or a cavity change to the preform design. A core change increases the inside diameter of the preform by hollowing out a portion of the inner wall of the preform. A cavity change does not affect the inner diameter but rather removes a portion of the outer wall of the preform. However, the thickness of the preform is related to, in part, the natural stretch ratio of the polymer being used to prepare the preform. That is, the natural stretch ratio of the polymer determines the stretch ratio of the preform, which is a function of the preform inner diameter correlating to thickness of the preform and height of the preform below the finish. The preform is designed to have a preform stretch ratio that is somewhat higher than the natural stretch ratio of the polymer, thus maximizing the performance of the PET resin by stretching the PET resin beyond its strain hardening point optimizing crystallization and orientation to create haze-free or substantially haze-free containers with acceptable mechanical performance. Increasing the inner diameter of a preform lowers the preform stretch ratio, which affects the final container properties by not maximizing the stretch of the PET resin. Therefore, it has been understood in the prior art that use of PET resin which has a natural stretch ratio typically in the range of about 13 to 16 as defined in the following paragraph has limitations in reducing energy costs in the container manufacturing process because the thickness of the preform cannot be effectively reduced.

One prior art method, which has been used to improve container quality, improve the productivity through reduced cycle time by using thinner walled preforms, and lessen energy consumption in manufacture, is to lower the stretch ratio of the polymer allowing for a reduced stretch ratio of the preform. Attempts have been made to lower the stretch ratio of the polymer by modification of the PET resin itself. This has been achieved by increasing the molecular weight or intrinsic viscosity (IV) of the PET resin because higher IV PET resins result in polymers with lower natural stretch ratios. However, when the IV of the PET resin is increased, the polymer will have higher melt viscosity. When higher melt viscosity is present, a higher melt temperature must be used to process the polymer. This results in more energy usage and also more potential for polymer degradation during processing. The higher melt temperature also requires longer cycle time during injection molding. These negative properties resulting from this method to lower the stretch ratio of the polymer thus outweigh any benefits described above in reducing the preform wall thickness.

Lowering of the polymer stretch ratio can also be accomplished by addition of long chain branching. However, like modifying the PET resin IV, this method also increases the melt viscosity of PET and caused the same problem of the high IV polymer. Thus, this method is not desirable.

In view of the above, it would be desirable to develop a preform design that does not result in higher energy consumption during processing. Still further, it would be desirable to develop a preform design that provides good mechanical properties in a finished stretch blow molded container such as, low thermal expansion, good sidewall rigidity and haze-free or substantially haze free containers. Still further, it would be desirable to reduce the energy consumption during injection molding the preform and, therefore, the container manufacturing process. The present invention meets these objectives.

### SUMMARY OF THE INVENTION

In one aspect, the present invention relates to performs for preparing stretch blow molded containers. Such preforms have stretch ratios that are distinguished from prior art preform designs. The present invention also relates to stretch blow molded containers made from such preforms. These stretch blow molded containers exhibit comparable mechanical and thermal properties with reduced cycle times and optionally lighter weight preforms over containers made from preforms made from prior art designs. Moreover, the stretch blow molded containers made in accordance with the present invention provide haze-free or substantially haze-free containers.

More particularly, this invention encompasses an injection molded preform for making a stretch blow molded container having an overall stretch ratio of from about 8 to about 12, wherein the overall stretch ratio is a product of a hoop stretch ratio and an axial stretch ratio, wherein the hoop stretch ratio is from about 4.5 to about 5.4, wherein the axial stretch ratio is from about 1.5 to about 2.2, and wherein the preform comprises a low natural stretch ratio (hereinafter “LNSR PET copolymer”) having a free blow volume of from about 400 to about 650 ml measured at 100° C. and 90 psi using a 25 gram weight preform designed for a 500 ml container with a maximum diameter of 65 mm and a height of 200 mm from below the container finish and having a hoop stretch ratio of 5.5 and an axial stretch ratio of 2.6. Furthermore, this invention encompasses a container made by blow molding such a preform. In a preferred embodiment, the preform comprises an open ended mouth forming portion, an intermediate body forming portion, and a closed base forming portion.

Additional advantages of the invention will be set forth in part in the detailed description, which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory aspects of the invention, and are not restrictive of the invention, as claimed.

### BRIEF DESCRIPTION OF DRAWINGS

FIG. 1 is a sectional elevation view of an injection molded preform having a conventional preform design as set forth in detail below.

FIG. 2 is a sectional elevation view of an injection molded preform having a LNSR design in accordance with one aspect of the invention and set forth in detail below.

FIG. 3 is a sectional elevation view of a blow molded container made from the preform of FIG. 2 in accordance with one aspect of the invention.

### DETAILED DESCRIPTION OF THE INVENTION

The present invention may be understood more readily by reference to the following detailed description of the invention and the examples provided herein and the Figures discussed herein. It is to be understood that this invention is not limited to the specific methods, formulations, and conditions described, as such may, of course, vary. It is also to be understood that the terminology used herein is for the purpose of describing particular aspects only and is not intended to be limiting.

In this specification and in the claims that follow, reference will be made to a number of terms, which shall be defined to have the following meanings.

The singular forms “a,” “an,” and “the” include plural referents unless the context clearly dictates otherwise.

Ranges may be expressed herein as from “about” one particular value and/or to “about” or another particular value. When such a range is expressed, another aspect includes from the one particular value and/or to the other particular value. Similarly, when values are expressed as approximations, by use of the antecedent “about,” it will be understood that the particular value forms another aspect.

“Optional” or “optionally” means that the subsequently described event or circumstance may or may not occur, and that the description includes instances where said event or circumstance occurs and instances where it does not. For example, the phrase “optionally comprising an ingredient” means that the composition may comprise that ingredient and that the description includes both compositions comprising that ingredient and compositions without that ingredient.

In one aspect, the present invention provides a preform having a reduced stretch ratio with certain hoop ratio and axial ratio limitations made from a polymer having a lower natural stretch ratio over preforms made from PET resin available in the prior art. The preform comprises an open ended mouth forming portion, an intermediate body forming portion, and a closed base forming portion. Still further, the present invention provides a stretch blow molded container having excellent mechanical properties, in particular a beverage container, made from this preform design. Also, the present invention provides a clear preform and a clear container or substantially clear preform and clear stretch blow molded container. In another aspect, the present invention provides haze-free or substantially haze free preforms and stretch blow molded containers.

In describing the present invention, two types of PET resin compositions will be defined for the different aspects of the invention. A container grade PET copolymer (hereinafter “CG PET copolymer” or “conventional PET”) is defined as having a free blow volume of from about 650 to about 800 milliliters (ml) measured at 100° C. and 90 pounds per square inch (psi) using a 25 gram weight preform designed for a 500 ml container with a maximum diameter of 65 mm and a height of 200 mm from below the container finish and having a hoop stretch ratio of 5.5 and an axial stretch ratio of 2.6. Examples of CG PET copolymers include PET copolymers having modification from about 1 to about 5 mole %, or from 1 to about 3 mole % 1,4 cyclohexanedimethanol modification, or alternatively, from about 1 to about 5 mole %, or from 1 to about 3 mole % isophthalic acid or naphthalene dicarboxylic acid modification.

A low natural stretch ratio copolymer (hereinafter “LNSR PET copolymer”) is defined as having a free blow volume of from about 400 to less than about 650 ml measured at 100° C. and 90 psi using a 25 gram weight preform designed for a 500 ml container with a maximum diameter of 65 mm and a height of 200 mm from below the container finish and having a hoop stretch ratio of 5.5 and an axial stretch ratio of 2.6. Examples of such are set forth below.

The free blow volume has a relational value to the natural stretch ratio of the polymer, which is more difficult to measure and requires special instrumentation. The free blow volume measurement of a neat polymer, as shown in the Examples herein, provides a method to measure the natural stretch ratio of a polymer. The natural stretch ratio of a polymer influences the preform design by determining the minimum stretch ratio limitations imparted to the preform by the polymer properties in the blow molding process. Thus, the free blow volume is the method chosen herein to describe the natural stretch ratio of the polymer. A standard 25 gram weight preform designed for a 500 ml container with maximum diameter of 65 mm and height of 200 mm below the container finish and having a hoop stretch ratio of 5.5 and an axial stretch ratio of 2.6 was chosen as the base measurement and standard test conditions of 100° C. and 90 psi were used, as shown in Example 1. For the container grade PET copolymer with the free blow volume in the range described above, the natural stretch ratio of such copolymer is from about 12 to 16. For the LNSR PET copolymer with the free blow volume in the range described above, the natural stretch ratio for such copolymer is from about 8 to about 12.

The preform stretch ratio is another valued used to describe the inventions herein. The preform stretch ratio refers to the nomenclature that is well known in the art and is defined according to the following formulas:
(1) Overall stretch ratio=[(maximum internal container diameter/internal preform diameter)]×[height of container below finish)/(height of preform below finish)]
(2) Hoop stretch ratio=(maximum internal container diameter/internal preform diameter)
(3) Axial stretch ratio=(height of container below finish/height of preform below finish)
(4) Or, in an alternate presentation, overall stretch ratio=hoop stretch ratio×axial stretch ratio

As noted above, in order to maximize the performance characteristics of a particular polymer the preform design must be such that the preform overall stretch ratio is greater than the natural stretch ratio of the PET copolymer. Using the above calculations, it would be recognized that there are virtually unlimited ways to obtain or design a specified preform stretch ratio for use with a particular PET copolymer. However, the inventors herein have determined that, although one can modify both axial and hoop stretch ratios to provide a specified preform overall stretch ratio, in accordance with the present invention there is a relationship that must be followed to achieve the optimum mechanical properties and barrier performance in the resulting container.

According to one aspect of this invention, the injection molded preforms of the present invention for making a stretch blow molded container for use with a LNSR PET copolymer are designed to have overall stretch ratios of from about 8 to about 12, or from 8 to 12, or from about 8 to about 10. In particular, within these specified overall stretch ratios, the hoop stretch ratio is from about 4.5 to about 5.4, or from 4.5 to 5.4, or from about 4.6 to about 5.2 or from about 4.6 to about 5.0. The axial stretch ratio is from about 1.5 to about 2.2, or from 1.5 to 2.2, or from about 1.5 to about 2.1, or from about 1.5 to about 2.0. Hereinafter, this design will be referred to as the “LNSR design”. The LNSR PET copolymer has a free blow volume of from about 400 to less than about 650 ml measured at 100° C. and 90 psi using a 25 gram weight preform designed for a 500 ml container with a maximum diameter of 65 mm and a height of 200 mm from below the container finish and having a hoop stretch ratio of 5.5 and an axial stretch ratio of 2.6. In another aspect, the LNSR PET has a free blow volume of from about 450 to about 600 ml or from about 500 to about 600 ml.

By varying the hoop and axial stretch ratios within these ranges to provide the specified overall stretch ratios formula, it has been found by the inventors herein that stretch blow molded containers having improved properties, such as greater thermal stability, reduced cycle time, and lower energy consumption, can be provided. These property improvements result in a number of benefits to a beverage product contained within the container such as, for example, improvements in beverage shelf life. Clear or substantially clear preforms and stretch blow molded containers are also found with this invention.

In a stretch blow molded container, the container generally conforms to the shape of a cylinder. As a result of this generally cylindrical shape, stresses placed on the structure during use, especially during the use of the carbonated soft drink are different in the hoop direction as in the axial direction. Generally speaking, the stress on the hoop direction is about twice as much as that on the axial direction. For carbonated soft drink, the stresses on the container sidewall caused by the internal pressure can cause the container to stretch. This phenomenon is also known as creep to those skilled in the art. Creep is bad for the product quality as well as the container quality. In particular, creep increases the volume of the container which, in turn, reduces the apparent fill level of the container. This can cause the false perception to the consumers that there is less product in the container. Creep can cause container deformation changing the container shape, which in many cases is representative of a brand. Creep also increases the head space volume of the CSD. This causes the CO2 to go from the beverage to the head space, and therefore reduce the amount of the CO2 in the beverage. Since the shelf life of the CSD is determined by the amount of CO2 in the beverage, the increased head space volume dramatically reduce the shelf life of the CSD product. Heat exacerbates this phenomenon causing even more thermal expansion or creep.

A conventional preform designed for a CG PET copolymer typically has an overall stretch ratio of about 12 to about 16, a hoop stretch ratio in the range of 4.3 to 5.5 and the axial stretch ratio in the range of 2.4 to 2.8. The inventors found that it is possible to increase the hoop stretch of the preform to achieve higher orientation in this direction, while reducing the axial stretch to reduce the orientation in this direction. By doing so, a higher degree of hoop orientation is achieved. Since the orientation of the container is related to the preform stretch ratio, the higher hoop stretch can increase the orientation in the hoop direction, and thus reduce the deformation in the hoop direction. From this discovery, it has been found that it can be beneficial to stretch the preform in the hoop direction to a greater degree than in the axial direction. In so doing, it has been found that a greater stretching in the hoop direction improves the orientation of the resulting beverage container, thus resulting in improved properties in the container.

In designing the preform of the present invention for a LNSR PET copolymer, the overall stretch ratio is lower than the conventional preforms. There are unlimited ways to achieve a lower overall stretch ratio. The inventors found that the containers had the best performance if the hoop stretch ratio was kept relatively unchanged, but the axial stretch ratio was dramatically reduced to reach the overall stretch ratio. To do so, the height of the preform is longer than conventional design preforms with the internal diameter being relatively the same, i.e. the axial stretch ratio is less relative to the hoop stretch ratio. This creates a preform that has a thinner sidewall when using the same gram weight. The stretch in the axial direction is substantially less than that of the hoop direction such that the hoop stretch ratio is from about 4.5 to about 5.4 and the axial stretch ratio is from about 1.5 to about 2.2 with the overall stretch ratio is from about 8 to about 12. Specifically, it has been found by the inventors herein that a longer, thinner walled preform than that found in the prior art provides benefits not previously seen. The benefits are especially true for reduced injection molding cycle time with the thinner preform sidewall thickness.

The present invention differs markedly from prior art methods of designing preforms with lower overall stretch ratios because such methods do not vary the hoop and axial stretch ratios in differing amounts as set forth in the present invention. Instead, these prior art methods of designing preforms look only to the overall stretch ratio desired and design the dimensions into the preform mold shape and, sometimes, a core change procedure. In particular, prior art methods of preform design vary the hoop and axial stretch ratios in a proportional fashion. With a core change procedure, the preform stretch ratio is reduced by reducing the hoop stretch ratio only. However, this is counter intuitive to the present invention since a core change either reduced the hoop stretch ratio and axial stretch ratio proportionally or reduced the hoop stretch ratio but kept the axial stretch ratio the same. Preforms designed in this manner, although may have thin sidewall thickness, do not produce containers that perform under pressure. Due to the low hoop stretch ratio in the container sidewall, a high degree of creep will occur and cause the issues mentioned above. These containers are known to those skilled in the art of poor performance in thermal stability, i.e., high creep.

In one aspect, the improvements seen with this LNSR design methodology can be observed in the resulting containers in a lower thermal expansion or creep of the containers in use. In use, the container will experience less thermal expansion and will therefore be of better quality. Yet further, the improvements are seen with increased sidewall rigidity in the finished container. Still further, improvements are seen in haze free or substantially haze free preforms and containers.

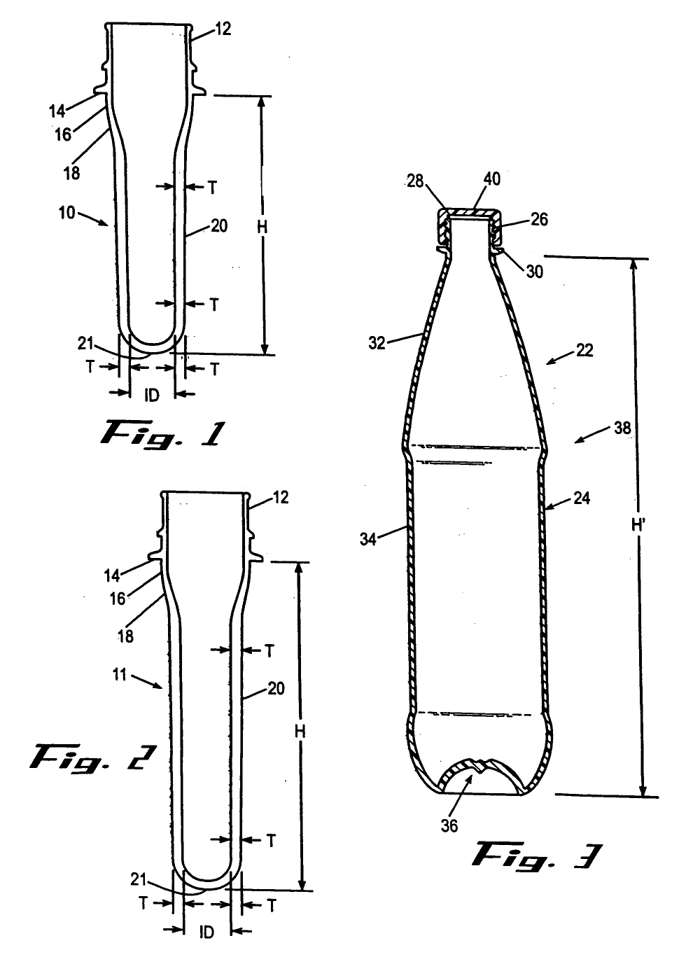

Turning to the FIGS. 1-3, a preform 10 having a conventional design is illustrated in FIG. 1 and a preform 11 having a LNSR design in accordance with one aspect of this invention is illustrated in FIG. 2. These preforms 10 and 11 in FIGS. 1 and 2 each have the same components, and therefore, like reference numerals indicate like components throughout the FIGS. The dimensions in FIGS. 1 and 2 are not drawn to scale.

The preforms 10 and 11 are made by injection molding a LNSR PET copolymer in one aspect of the present invention. Such preforms comprise a threaded neck finish 12 which terminates at its lower end in a capping flange 14. Below the capping flange 14, there is a generally cylindrical section 16 which terminates in a section 18 of gradually decreasing external diameter so as to provide for an increasing wall thickness. Below the section 18 there is an elongated body section 20. The height of the preform is measured from the capping flange 14 to a closed end 21 of the elongated body section 20.

The preforms 10 and 11 illustrated in FIGS. 1 and 2 can each be blow molded to form a container 22 illustrated in FIG. 3. The container 22 comprises a shell 24 comprising a threaded neck finish 26 defining a mouth 28, a capping flange 30 below the threaded neck finish, a tapered section 32 extending from the capping flange, a body section 34 extending below the tapered section, and a base 36 at the bottom of the container. The height of the container is measured from the capping flange 30 to a closed end at the base 36. The container 22 is suitably used to make a packaged beverage 38, as illustrated in FIG. 3. The packaged beverage 38 includes a beverage such as a carbonated soft drink beverage disposed in the container 22 and a closure 40 sealing the mouth 28 of the container.

In one aspect of the present invention, the intermediate body forming portion of the inventive preforms can have a wall thickness from about 1.5 to about 8 mm. The intermediate body forming portion of the preform can also have an inside diameter from about 10 to about 30 mm, and the height of the preform, which extends from the closed end of the preform opposite the finish to the finish, is from 50 to 150 mm. In one aspect, containers made in accordance with some aspects of this invention can have a volume within the range from about 0.25 to about 3 liters and a wall thickness of about 0.25 to about 0.65 mm. However, it is important to note that in relation to the preform of the LNSR design of the present invention, the overall stretch ratio and the axial and hoop stretch ratios must vary in accordance with the formulas stated herein.

In this specification, reference is made to dimensions of the preforms 10 and 11 and the resulting containers 22. The height H of the preforms is the distance from the closed end 21 of the preform opposite the finish 12 to the capping flange 14 of the finish. The internal diameter ID of the preforms 10 and 11 is the distance between the interior walls of the elongated body section 20 of the preforms. The wall thickness T of the preforms 10 and 11 is measured at the elongated body section 20 of the preforms also. The height H′ of the container 22 is the distance from the closed end of the base 36 of the container opposite the finish 26 to the capping flange 30 of the finish. The maximum internal container diameter MD is the diameter of the container at its widest point along the height of the container 22. The hoop stretch ratio of the preforms equals the maximum internal container diameter divided by the internal preform diameter and the axial stretch ratio equals the height of container below the finish divided by the height of preform below the finish. The overall stretch ratio of the preforms equals the product of the hoop stretch ratio and the axial stretch ratio.

The preform 11, container 22, and packaged beverage 38 are but exemplary embodiments of the present invention. It should be understood that the LNSR PET copolymer that comprises one aspect of the present invention can be used to make a variety of preforms and containers having a variety of configurations.

In certain aspects, the preforms of the present invention can be prepared from LNSR PET copolymers, which have stretch ratios that are a minimum of about 10% less than conventional PET, or a minimum of about 20% less than conventional PET, or a minimum of about 25% less than conventional PET copolymers that have been used in the prior art to prepare beverage containers. The stretch ratios are defined below using a free blow volume calculation.

In further aspects, the LNSR PET copolymers made in accordance with the present invention exhibit free blow volumes that are about 18 to about 30% less free blow volume than a preform made with the conventional design and measured at 100° C. and 90 psi using a 25 gram weight preform designed for a 500 ml container with a maximum diameter of 65 mm and a height of 200 mm from below the container finish and having a hoop stretch ratio of 5.5 and an axial stretch ratio of 2.6.

In one aspect, a LNSR PET copolymer is used to prepare stretch blow molded containers from the LNSR designs of the present invention. The LNSR PET copolymer comprises a diol component having repeat units prepared from an ethylene glycol and a non-ethylene glycol diol component and a diacid component having repeat units from terephthalic acid and a non-terephthalic acid diacid component, wherein the total amount of non-ethylene glycol diol component and non-terephthalic acid diacid component is present in the PET copolymer in an amount from about 0.2 mole percent to less than about 2.2 mole percent. The mole percentages of diol components and diacid components include all residual comonomers in the PET copolymer composition such as those formed during or passing through the manufacturing process of the PET copolymer. As used herein, the composition of a polymer is based on a total of 200 mole percent including 100 mole percent of the diol component and 100 mole percent of the diacid component. This means that the mole percentage of diethylene glycol is based on 100 mole % of diol component and the mole percentage of the naphthalene dicarboxylic and is based on 100 mole percent diacid component. This definition is applicable throughout this specification.

The amount of each of the non-ethylene glycol diol component and non-terephthalic acid diacid component in the LNSR PET copolymer can vary to some extent within the total amount of either material, which can be from about 0.2 mole percent to less than about 2.2 mole percent. In one aspect, the total amount of non-ethylene glycol diol component and non-terephthalic acid diacid component present in the LNSR PET copolymer having a desirable stretch ratio is from about 1.1 mole percent to about 2.1 mole percent, or from about 1.2 mole percent to about 1.6 mole percent. Repeat units from the non-terephthalic acid diacid component are can be present in the LNSR PET copolymer at from about 0.1 to about 1.0 mole percent, or from about 0.2 to about 0.75 mole percent, or from about 0.25 to about 0.6 mole percent, or yet further at from about 0.25 to less than about 0.5 mole percent.

The repeat units from the non-ethylene glycol diol component can be present in the LNSR PET copolymer at from about 0.1 to about 2.0 mole percent, or from about 0.5 to about 1.6 mole percent, or from about 0.8 to about 1.3 mole percent.

The LNSR PET copolymer suitable for use in the invention herein can have an intrinsic viscosity (IV), measured according to ASTM D4603-96 (incorporated by reference herein), of from about 0.6 to about 1.1 dL/g, or from about 0.70 to about 0.9, or from about 0.80 to about 0.84.

The LNSR PET copolymer suitable for use in the invention herein can comprise a reaction grade resin, meaning that the PET resin is a direct product of a chemical reaction between comonomers and not a polymer blend.

In another aspect of the invention, containers can be made from the LNSR designs of the present invention comprising a LNSR PET copolymer comprising a diol component having repeat units from ethylene glycol and a non-ethylene glycol diol component and a diacid component having repeat units from terephthalic acid and a non-terephthalic acid diacid component. The total amount of a non-ethylene glycol diol component and a non-terephthalic acid diacid component present in the LNSR PET copolymer can be from about 0.2 mole percent to less than about 3.0 mole percent based on 100 mole percent of the diol component and 100 mole percent of the diacid component. The non-ethylene glycol diol component can be from about 0.1 to about 2.0 and the non-terephthalic acid diacid component is from about 0.1 to about 1.0. The total amount of non-ethylene glycol diol component and non-terephthalic acid diacid component can be from about 0.2 mole percent to less than about 2.6 mole percent.

The non-terephthalic acid diacid component can be any of a number of diacids, including, but not limited to, adipic acid, succinic acid, isophthalic acid (IPA), phthalic acid, 4,4′-biphenyl dicarboxylic acid, naphthalenedicarboxylic acid, and the like. In one aspect, the non-terephthalate acid diacid component can be 2,6-naphthalenedicarboxylic acid (NDC). The non-ethylene glycol diols that may be used in the present invention include, but are not limited to, cyclohexanedimethanol, propanediol, butanediol, and diethylene glycol. Of these, diethylene glycol (DEG) can comprise an aspect of the invention, as limited below. The non-terephthalic acid diacid component and the non-ethylene glycol diol component can also be mixtures of diacids and diols, respectively.

The levels of DEG in the LNSR PET copolymer that can be used in the preform designs of the present invention range from about 0.1 to about 2.0 mole percent, which is below the typical residual levels of DEG present in the manufacture of conventional PET. Conventional PET typically contains from about 2.4 to about 2.9 mole percent DEG, which is equivalent to more commonly referenced weight percent values of about 1.3 to about 1.6. Additionally, in other aspects of the present invention conventional PET may also be equated to CG PET copolymer as defined above.

Those skilled in the art of PET manufacture generally regard DEG as a harmless by-product of the polymer manufacture; consequently, little effort has been directed toward reduction of DEG levels in PET intended for use in containers. Thus, in one aspect of the present invention, modifications to the PET production process for containers must be made to achieve the lower DEG levels in the LNSR PET copolymer that can be used to prepare the preforms of the present invention.

To prepare LNSR PET copolymer having low amounts of DEG, any method suitable for reducing DEG content of polyester can be employed. Such methods can include reducing the mole ratio of diacid or diester relative to ethylene glycol in the esterification or polycondensation reaction; reducing the temperature of the esterification or polycondensation reaction, addition of DEG-suppressing additives, including tetra-alkyl ammonium salts and the like; and reduction of the DEG content of the ethylene glycol that is recycled back to the esterification or polycondensation reaction.

In another aspect of the present invention, a method for making a container is provided, wherein the method comprises blow molding an injection molded preform having the relationships of hoop, axial and overall stretch ratios of the LNSR design for use with LNSR PET copolymer as described elsewhere herein.

In another aspect of the present invention, the cycle time of the preform manufacturing process can be reduced by use of the LNSR designs of the present invention. The preform walls are thinner because of the lower overall stretch ratio. This is achieved by reducing the axial stretch ratio and keeping the hoop stretch ratio relatively unchanged. The cycle time for making the preform using the LNSR designs of the present invention is significantly reduced as compared to a the cycle time of a preform using conventional designs. In this aspect, a method for reducing the cycle time for making a stretch blow molded container comprising the steps of:
a) providing a melted LNSR PET copolymer having a free blow volume of from about 400 to less than about 650 ml measured at 100° C. and 90 psi using a 25 gram weight preform designed for a 500 ml container with maximum diameter of 65 mm and height of 200 mm from below the container finish and having a hoop stretch ratio of 5.5 and an axial stretch ratio of 2.6;
b) injecting the LNSR PET copolymer into a heated mold;
c) cooling the mold and the contained LNSR PET copolymer thereby providing a preform suitable for preparing a stretch blow molded container, wherein the preform has an overall stretch ratio of from about 8 to about 12, wherein the overall stretch ratio is a product of a hoop stretch ratio and an axial stretch ratio, wherein the hoop stretch ratio is from about 4.5 to about 5.4, and wherein the axial stretch ratio is from about 1.5 to about 2.2; and
d) stretch blow molding the preform, thereby providing a stretch blow molded container,
wherein the cycle time for making the preform is at least 5% less than the cycle time required to prepare a preform with an overall stretch ratio of greater than 12. In another aspect, the cycle time for making the preform is at least 10% less.

To understand the significance of one aspect of the present invention, a summary of the conventional process of making stretch blow molded containers is provided. First, PET pellets obtained from a conventional polyester esterification/polycondensation process are melted and subsequently formed into preforms through an injection molding process using known processes. Second, the preforms are heated in an oven to a temperature above the polymer Tg, and then formed into containers via a known blow molding process. The desired end result is clear preforms and clear containers with sufficient mechanical and barrier properties to provide appropriate protection for the contained beverage or food product stored within the container.

As would be understood by one of ordinary skill in the art, an important consideration in producing clear or transparent containers is to first produce clear or transparent preforms. During the injection molding step, thermally induced crystallization can occur during the conversion of the polymer to a preform. Thermally induced crystallization can result in the formation of large crystallites in the polymer, along with a concomitant formation of haze. In order to minimize the formation of crystallites and thus provide clear preform, the rate of thermal crystallization should be slow enough so that preforms with few or no crystallites can be produced. However, if the rate of thermal crystallization is too low, the production rates of PET resin can be adversely affected, since PET must be thermally crystallized prior to solid-state polymerization, a process used to increase the molecular weight of PET and simultaneously remove unwanted acetaldehyde. Solid state polymerization increases the molecular weight of the polymer so that a container made from the polymer will have the requisite strength.

Prior art techniques for reducing thermal crystallization rate include the use of PET containing a certain amount of co-monomers. The most commonly used comonomer modifiers are isophthalic acid or 1,4-cyclohexanedimethanol, which are added at levels ranging from 1.5 to 3.0 mole %.

Counterbalancing the need to reduce the rate of thermal crystallization during injection molding is the need to increase the rate of strain-induced crystallinity that occurs during blow molding. Strain-induced crystallization results from the rapid mechanical deformation of PET, and generates extremely small, transparent crystallites. The amount of crystallites present in the container sidewall correlates generally with the strength and barrier performance of the container.

Using a LNSR PET copolymer, such as a PET incorporating a non-terephthalic acid diacid and a low amount of DEG as discussed further herein, to prepare the preforms of the present invention has been unexpectedly found to provide both a reduced rate of thermal crystallization and an increased rate of strain-induced crystallization. This result is surprising because it was previously thought that at very low levels of DEG (such as where the polymer was close to PET homopolymers form) the rate of thermal crystallization of PET polymer would be very fast. In contrast, the degree of thermal crystallization with low DEG in this aspect of the present invention is controllable.

As shown in the examples, this result is found with use of a non-terephthalic acid diacid such as NDC in the PET in the amounts set forth elsewhere herein. Without being bound by theory, it is believed that this thermal crystallization rate of the PET copolymer is reduced due to the rigidity of the NDC moiety hindering polymer chain flexibility, and thus making formation of crystallites more difficult. The addition of NDC to the low DEG PET copolymer has also been discovered by the inventors herein to enhance the stiffness of the PET chains and results in an unexpected increase in the sidewall rigidity of the containers. Such increased sidewall rigidity is especially apparent when the preform design of one aspect of the present invention is utilized. In certain aspects of the present invention, NDC is present at from greater than 0 to about 2% mole percent. In such aspects, it has been found important to include at least some NDC along with the reduced amount of DEG. Significantly, inclusion of some NDC has been found to allow preparation of clear containers. Without being bound by theory, it is believed that the inclusion of NDC slows the crystallization of the PET copolymer, thus allowing the formation of clear or substantially clear containers.

Furthermore and contrary to expectations, reduction of the DEG content to less than about 2.0 mole percent in the LNSR PET copolymer results in an increase in the rate of strain-induced crystallization relative to conventional PET containing between 2.4 and 2.9 mole percent DEG.

The LNSR polymer is separately disclosed and claimed in copending U.S. patent application Ser. No. 10/967,803 filed in the U.S. Patent and Trademark Office on Oct. 18, 2004, which is a continuation of U.S. patent application Ser. No. 10/696,858 filed in the U.S. Patent and Trademark Office on Oct. 30, 2003, which claims priority under 35 U.S.C. §119 to U.S. provisional patent application Ser. No. 60/423,221 filed on Nov. 1, 2002, the disclosures of which is incorporated herein in its entirety by this reference.

The inventors herein have found that the combination of low amounts of DEG and NDC in the presented ranges results in a reduction in the low natural stretch ratio of PET copolymer in comparison to that of conventional PET. When used in conjunction with the LNSR designs as discussed herein and, for example, described in FIG. 2, it has been found possible to obtain a stretch blow molded container with superior thermal and mechanical properties as compared to containers made from conventional PET. Moreover, because these mechanical and thermal properties exceed the values needed for certain container applications, the amount of PET polymer used in the container manufacture can be reduced while still allowing one to obtain containers with acceptable thermal and mechanical properties. That is, the inventors have discovered that a lightweight container can be prepared with less polymer usage, where the container exhibits excellent thermal and mechanical properties.

The present invention can be more fully appreciated when comparing container properties relative to the preform stretch ratio. A preform designed to have a stretch ratio of about 14 (which is a conventional preform design) and a sidewall thickness of about 3.2 mm using conventional PET will result in a blow molded container having a sidewall thickness of about 0.23 mm. When using the preform design of FIG. 1 (which is a prior art preform design) within the LNSR PET copolymer described elsewhere herein, a stretch blow molded container will have a sidewall thickness of about 0.35 mm. This container thickness is significantly greater than the thickness needed in a stretch blow molded container. Thus, the inventors herein have determined that the amount of polymer used to prepare the preform can be reduced using the preform design methodology of the present invention. As such, the preform design methodology has been discovered to allow the preparation of lightweight stretch blow molded containers having wall thicknesses equal to or approximately equal to stretch blow molded containers made using prior art preform designs and/or prior art PET polymers (that is, “conventional PET”). To obtain a finished container sidewall thickness of 0.23 mm (which is a specific sidewall thickness that is used commercially to prepare CSD containers) using the LNSR PET copolymer described in the inventive preform is designed according to the described formula to be longer and thinner because it has been found that a thinner walled preform can yield a stretch blow molded container with excellent properties, if the hoop, axial and overall stretch ratios are varied in accordance with the described formula.

Still further, it has been found that the preform design could be modified to exemplify the properties of the polymer so as to obtain a stretch blow molded container suitable for the intended use. However, it is important to note that the present invention should not be limited to the specific preform design (as long as hoop, axial and overall stretch ratio formulas are adhered to) because the benefits obtained by the design of the preform are believed by the inventors herein to be applicable to any stretch blow molded container prepared from a preform.

Further, the sidewall thickness of the preform correlates with the injection molding cooling time. The cooling time is proportional to the square of the wall thickness. Since injection molding cycle time is, to a large degree, determined by cooling time, the preform design of the present invention has been found to substantially reduce the injection molding cycle time because the preform sidewall thickness is less.

The preform designs of the present invention can be used to make stretch blow molded containers. Such containers include, but are not limited to, containers, drums, carafes, and coolers, and the like. As is well known to those skilled in the art, such containers can be made by blow molding an injection molded preform. Examples of suitable preform and container structures and methods for making the same are disclosed in U.S. Pat. No. 5,888,598, the disclosure of which is incorporated herein by reference in its entirety. Other preform and stretch blow molded container structures known to one of skill in the art can also be prepared in accordance with the present invention.

The present invention is described above and further illustrated below by way of examples, which are not to be construed in any way as imposing limitations upon the scope of the invention. To the contrary, it is to be clearly understood that resort may be had to various other embodiments, modifications, and equivalents thereof which, after reading the description herein, may suggest themselves to those skilled in the art without departing from the spirit of the present invention and/or scope of the appended claims.

### EXAMPLES

The following Examples are put forth so as to provide those of ordinary skill in the art with a complete disclosure and description of how the compounds claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° F. or is at room temperature, and pressure is at or near atmospheric.

Examples were conducted using the prior art preform design of FIG. 1 and the inventive preform design described herein and, in one aspect, shown in FIG. 2 as noted.

### Example 1

Different PET resins were dried overnight at 135° C. in a vacuum oven to achieve a moisture level below 50 ppm prior to injection molding. The injection molding was performed with a lab-scale Arburg unit cavity injection machine into conventional preform molds using a 25 gram weight preform designed for a 500 ml container with a maximum diameter of 65 mm and a height of 200 mm from below the container finish and having a hoop stretch ratio of 5.5 and an axial stretch ratio of 2.6. The preforms were then free blown to bubbles to determine the stretch ratio of each polymer. Free blow was performed on each preform variable and the bubbles were blown at temperatures of 100° C. and 90 psi. The free blow volume is an indication of the natural stretch ratio of the PET, and is recorded for each bubble. The higher the free blow volume, the higher the natural stretch ratio of the PET.

TABLE 1
Free blow results of the LNSR PET copolymer as compared to
the CG PET Copolymer

| Resin Composition | | | |
|---|---|---|---|
| mole % | mole % | mole % | Free blow |
| IPA | DEG | NDC | volume (ml) |
| 3 | 2.80 | 0 | 713 (comp) |
| 0 | 1.60 | 0 | 532 |
| 0 | 1.60 | 0.25 | 542 |
| 0 | 1.60 | 0.50 | 520 |
| 0 | 1.60 | 1.00 | 560 |
| 0.50 | 1.60 | 0 | 529 |

The first resin with 3 mole % IPA and 2.8 mole % of DEG is a conventional PET resin. It is seen from Table 1 that the other resins have reduced free blow volume and thus exhibit a lower natural stretch ratio than that of the conventional PET copolymer.

To further illustrate the inventive preform design, one conventional PET resin and one LNSR PET copolymer were produced as described in Table 2. These two resins will be used in the following examples.

TABLE 2
Resin description

| Resin | | | DEG | |
|---|---|---|---|---|
| composition | IPA (mole %) | NDC (mole %) | (mole %) | Preform IV |
| C1 (comp) | 2.8 | 0 | 2.9 | 0.78 |
| LNSR PET | 0 | 0.5 | 1.5 | 0.79 |
| Copolymer | | | | |

The resins were injection molded into preforms conforming to the inventive design of FIG. 2 and free blow measurements were performed on these preforms. This time, in addition to the free blow volume, the stretch ratio was also measured by measuring the dimension change of a pre-stuck circle on the bubble v/s preform. The calculated stretch ratio is shown in Table 3.

TABLE 3
Stretch ratio of the free blow bubble

| | Free blow volume | Overall stretch | % reduction of the |
|---|---|---|---|
| Resins | (ml) | ratio | stretch ratio |
| C1 (comp) | 700 | 14.81 | N/A |
| LNSR PET | 525 | 11.81 | 20% |
| Copolymer | | | |

The above bubble was further analyzed by calculating the hoop and axial stretch ratio as shown in Table 4

TABLE 4

| | Inside hoop | |
|---|---|---|
| Resins | stretch ratio | Inside axial stretch ratio |
| C1 (comp) | 5.2 | 2.7 |
| LNSR PET Copolymer | 4.9 | 2.1 |

### Example 2

### Performance of the LNSR Design

A preform design conforming to FIG. 2, the LNSR preform design, was used for both 24-g and 27-g preform with reduced wall thickness (that is, having the disclosed relationship between hoop, axial and overall stretch ratio) over the conventional preform designs for a 500 ml contour container. The LNSR PET copolymer resin was then injection molded into these preforms using a lab scale Arburg injection molding machine. This Example demonstrates the cycle time reduction with the thinner sidewall preform. The results are shown in Table 5.

TABLE 5

| | Preform Design | | | |
|---|---|---|---|---|
| | Conv | LNSR | Conv | Core |
| | Preform | Preform | Preform | Change |
| LNSR PET | (FIG. 1) | Design | (FIG. 1) | Preform |
| Copolymer | (comp) | (FIG. 2) | (comp) | Design |
| Preform weight | 24 | 24 | 27 | 27 |
| (grams) | | | | |
| Hoop stretch ratio | 4.86 | 4.93 | 5.24 | 4.35 |
| Axial stretch ratio | 2.52 | 1.95 | 2.34 | 1.95 |
| Preform stretch ratio | 12.25 | 9.61 | 12.26 | 8.48 |
| Height (mm) | 80.74 | 103.99 | 86.95 | 103.99 |
| Inside diameter | 13.69 | 13.50 | 12.69 | 15.30 |
| (mm) | | | | |
| Wall thickness (mm) | 3.43 | 2.65 | 3.86 | 2.80 |
| Cycle Time (sec) | 23.6 | 17.9 | 28.5 | 21.0 |

It is seen that with the thinner sidewall, a cycle time reduction of 24 to 26% is seen using the Arburg laboratory machine. This reduction in cycle time will result in a significant reduction in the amount of energy needed to manufacture a stretch blow molded container.

To further demonstrate this improvement, a preform was designed with a Husky injection molding machine that can simulate the production injection molding and to provide a direct comparison with a production machine. The preform dimensions are listed in Table 6 and the LNSR PET copolymer was injection molded with a Husky HL90 RS35/35 injection molding machine.

TABLE 6
Husky injection molding

| | LNSR |
|---|---|
| | preform |
| LNSR PET | design |
| Copolymer | (FIG. 2) |
| Preform weight | 25 |
| (grams) | |
| Hoop stretch ratio | 4.89 |
| Axial stretch ratio | 2.00 |
| Preform stretch | 9.78 |
| ratio | |
| Height (mm) | 98.5 |
| Inside diameter | 13.30 |
| (mm) | |
| Wall thickness (mm) | 2.97 |
| Cycle Time (sec) | 12.2 |

When a conventional PET preform (that is, the preform design of FIG. 1), with 3.43 mm sidewall thickness was produced using the same simulation machine, a cycle time of 14.5 s was seen. This further demonstrates the cycle time reduction using the inventive preform design.

### Example 3

The preform design from Example 2, Table 5, using both control resin C1 (which is a conventional PET polymer) and the LNSR PET copolymer were blown into 500-ml contour containers with a SBO-1 blow molding machine. The thermal stability test was performed according to the procedure as described hereinafter. The thermal stability test is used to measure physical changes in container dimensions caused by temperature and pressure stresses. The thermal stability measurements were made as follows:

The “as received” test container dimensions and thickness are measured. Containers are then filled with water carbonated to 4.1+/−0.1 volumes and capped. The filled containers are exposed to ambient temperature overnight, and the dimensions are measured to determine percent change. The containers are exposed at 38° C., and the dimensions are measured to determine percent change. Twelve test samples are labeled with test request and sample numbers on the bottom half of the container using a permanent ink marker. After dimensional measurements are taken at ambient temperature, the samples are stored in the environmental chamber at 38° C. for 24 hours. Measurement of fill point drop, doming and dimensions are completed for filled containers conditioned after the 38° C. environmental chamber. The minimum, maximum, average, and standard deviation values of all dimensions are calculated for each day of testing. The critical dimensional change is listed in Table 7.

TABLE 7
Thermal stability results

| | % diameter | | |
|---|---|---|---|
| Resin | change | % height change | Fill point drop (in) |
| C1 | 1.80 | 2.70 | 0.963 |
| LNSR PET | 1.73 | 1.36 | 0.798 |
| Copolymer | | | |

The LNSR PET copolymer with the LNSR design outperformed containers made from conventional PET using the LNSR design and passed all commercial specifications.

### Example 4

LNSR PET copolymer was injection molded into the following preforms designed for a 600 ml contour container. Two conventional preform designs were used. They are termed “conventional” preform designs because the lower stretch ratio is achieved by reducing the hoop stretch ratio and keeping the axial stretch ratio the same, which is the easier way to accomplish a change in preform stretch ratio. Compared with the inventive preform design, the conventional designs have higher overall stretch ratio, but lower hoop stretch ratio, as demonstrated in Table 8.

In particular, this example demonstrates that there are virtually unlimited ways to design a preform with a subset of the hoop, axial and overall stretch ratios claimed. For example, the column denoted “Prior Art Preform Design” has a hoop stretch ratio and an axial stretch ratio within the ranges set for these parameters, however, the product of these stretch ratios (which is the overall stretch ratio) is greater than 12.

TABLE 8
preform designs

| | LNSR | Prior art | Prior art |
|---|---|---|---|
| | preform | conventional | core change |
| LNSR PET copolymer | design | preform design A | preform design B |
| Design | | | |
| Preform weight (grams) | 25 | 26.5 | 24.5 |
| Hoop stretch ratio | 4.89 | 4.67 | 4.37 |
| Axial stretch ratio | 2.00 | 2.69 | 2.69 |
| Overall preform stretch | 9.78 | 12.56 | 11.77 |
| ratio | | | |
| Height (mm) | 98.5 | 79.5 | 79.5 |
| Inside diameter (mm) | 13.30 | 14.87 | 15.89 |
| Wall thickness (mm) | 2.97 | 3.63 | 3.13 |

The resins were dried at 135° C. overnight to moisture level less than 50 ppm. The preforms were injection molded with an Arburg lab scale injection molding machine. The preforms were then blown into 600 ml contour containers with a SBO-2 blow molding machine. The thermal stability of the containers was tested using the same method as described above. Also included in the below Table 9 are the results from Table 7 which are the thermal stability results using the inventive preform design.

TABLE 9
thermal stability results

| | | % diameter | % height | Fill point |
|---|---|---|---|---|
| Polymer | | change | change | drop (in) |
| LNSR PET | Prior Art | 2.10 | 1.50 | 1.049 |
| Copolymer | Preform Design A | | | |
| LNSR PET | Prior Art | 3.33 | 1.70 | 1.242 |
| Copolymer | Preform Design B | | | |
| LNSR PET | LNSR Preform | 1.73 | 1.36 | 0.963 |
| Copolymer | Design | | | |
| Conventional | LNSR Preform | 1.80 | 2.70 | 0.798 |
| PET | Design | | | |
| copolymer | | | | |

As can be seen from Table 9, the LNSR preform design resulted in containers that demonstrated good thermal stability results measured by dimensional change. Comparing Table 9 results with Table 7 results, it can be seen that although the LNSR preform design has total lower stretch ratio than both Prior Art Preform designs A and B, the containers produced from LNSR preform design have much better performance than the containers produced from either Prior Art Preform Designs A and B. The difference is in the relative hoop and axial stretch ratios. Although Prior Art Preform Designs A and B preforms have higher overall stretch ratio, it has lower hoop stretch ratio. This is to show that there are numerous ways of designing a preform with overall stretch ratio between 8 and 12, but only with the defined hoop and axial stretch ratios for the LNSR PET copolymer provide good results when blow into containers. As hoop stretch ratio is most important in determining the expansion, the containers made from the LNSR preform designs performed better than that of the containers from Prior Art Preform Designs A and B. Also, it is significant that containers made with the conventional PET, but with the LNSR preform design demonstrate improved properties in 2 out of 3 measured categories. This demonstrates that the LNSR preform designs can be used with conventional PET although not with optimum results.

It is therefore important to design the preforms not only has the overall stretch ratio, but also has certain hoop and axial stretch ratios to maximize performance.

It will be apparent to those skilled in the art that various modifications and variations can be made in the present invention without departing from the scope of the invention. Other aspects of the invention will be apparent to those skilled in the art from consideration of the specification and practice of the invention disclosed herein. It is intended that the specification and examples be considered as exemplary only.

1. An injection molded preform for making a stretch blow molded container having an overall stretch ratio of from about 8 to about 12, wherein the overall stretch ratio is a product of the hoop stretch ratio and the axial stretch ratio, wherein the hoop stretch ratio is from about 4.5 to about 5.4 and the axial stretch ratio is from about 1.5 to about 2.2, and wherein the preform comprises a LNSR PET copolymer having a free blow volume of from about 400 to less than about 650 ml measured at 100° C. and 90 psi using a 25 gram weight preform designed for a 500 ml container with maximum diameter of 65 mm and height of 200 mm from below the container finish and having a hoop stretch ratio of 5.5 and an axial stretch ratio of 2.6.

2. The preform of claim 1, wherein the overall preform stretch ratio is from about 8 to about 10.

3. The preform of claim 1, wherein the hoop stretch ratio is from about 4.6 to about 5.2.

4. The preform of claim 3, wherein the hoop stretch ratio is from about 4.6 to about 5.0.

5. The preform of claim 1, wherein the axial stretch ratio is from about 1.5 to about 2.1.

6. The preform of claim 5, wherein the axial stretch ratio is from about 1.5 to about 2.0.

7. The preform of claim 1, wherein the free blow volume of the LNSR PET copolymer is from about 450 to about 600 ml.

8. The preform of claim 7, wherein the free blow volume of the LNSR PET copolymer is from about 500 to about 600 ml.

9. The preform of claim 1, wherein the preform is substantially haze free.

10. A stretch blow molded container prepared from the preform of claim 1.

11. The stretch blow molded container of claim 10, wherein the container is substantially haze free.

12. The stretch blow molded container of claim 10 in the form of a container for beverages.

13. The stretch blow molded container of claim 12, further comprising a beverage contained therein.

14. The stretch blow molded container of claim 13, wherein the beverage is a carbonated soft drink.

15. A method for reducing the cycle time for making a stretch blow molded container comprising the steps of:
a) providing a melted LNSR PET copolymer having a free blow volume of from about 400 to less than about 650 ml measured at 100° C. and 90 psi using a 25 gram weight preform designed for a 500 ml container with maximum diameter of 65 mm and height of 200 mm from below the container finish and having a hoop stretch ratio of 5.5 and an axial stretch ratio of 2.6;
b) injecting the LNSR PET copolymer into a heated mold;
c) cooling the mold and the contained LNSR PET copolymer thereby providing a preform suitable for preparing a stretch blow molded container, wherein the preform has an overall stretch ratio of from about 8 to about 12, wherein the overall stretch ratio is a product of a hoop stretch ratio and an axial stretch ratio, wherein the hoop stretch ratio is from about 4.5 to about 5.4, and wherein the axial stretch ratio is from about 1.5 to about 2.2; and
d) stretch blow molding the preform, thereby providing a stretch blow molded container,
wherein the cycle time for making the preform is at least 5% less than the cycle time required to prepare a preform with an overall stretch ratio of greater than 12.

16. The preform of claim 15, wherein the overall preform stretch ratio is from about 8 to about 10.

17. The preform of claim 15, wherein the axial stretch ratio is from about 1.5 to about 2.1.

18. The preform of claim 15, wherein the axial stretch ratio is from about 1.5 to about 2.0.
